(19) United States
(12) Patent Application Publication
(10) Pub. No.: US 2025/0178769 A1
(43) Pub. Date: Jun. 5, 2025

(54) HANDHELD LABEL PRINTER WITH COLOR SENSING CAPABILITIES

(71) Applicant: Avery Dennison Retail Information Services LLC, Mentor, OH (US)

(72) Inventors: Timothy L. BROWN, Dayton, OH (US); Kyle E. FROST, West Carrollton, OH (US); John D. MISTYURIK, Troy, OH (US); Richard E. SCHWABE, Centerville, OH (US)

(21) Appl. No.: 18/842,850

(22) PCT Filed: Mar. 30, 2023
(86) PCT No.: PCT/US2023/065137

§ 371 Date: Aug. 30, 2024

Related U.S. Application Data
(60) Provisional application No. 63/325,261, filed on Mar. 30, 2022.

(51) Int. Cl. B65C 11/02; B41J 3/407; B41J 3/46; B41J 11/00; B41J 15/04; B41J 29/13; H04N 1/00

(52) U.S. Cl. CPC B65C 11/0215; B41J 3/4075; B41J 3/46; B41J 11/0095; B41J 15/042; B41J 29/13; H04N 1/00334; B65C 2210/0008; B65C 2210/0013; B65C 2210/0043; B65C 2210/0089; B65C 2210/0094

(57) ABSTRACT

In some embodiments, a handheld label application device includes a housing assembly, a print head mounted inside the housing assembly and configured to print on a label, and a sensor positioned inside the housing assembly, wherein the sensor is configured to detect at least one optical attribute of a label before it is printed on by the printer.

### CROSS-REFERENCE TO RELATED APPLICATION(S)

The present application claims priority to and the benefit of U.S. Provisional Patent Application No. 63/325,261, filed Mar. 30, 2022, the entirety of which is incorporated herein by reference in its entirety.

### TECHNICAL FIELD

The present subject matter, in general, relates to handheld label printers and in particular relates to a handheld label printer with a sensor for detecting color of labels.

### BACKGROUND

Globalization has drastically raised market requirements and needs of various goods and products to support our daily requirements. In the recent past, production supply and demand have increased significantly and have also lead to developments in manufacturing, production, transfer and sales of goods and products. In order to process high demands, tracking and tracing items has played a vital role in managing the chain of operations in manufacturing, production, transfer and sales of goods and products. Machine readable labels and tags have been used to facilitate monitoring of the goods and products. Such labels may be printed using label printers and then applied to the goods and products.

Label printers are being used to apply labels on products, packages, materials, containers and other objects. Desk label printers or handheld label printers dispense labels that are applied to the surface of objects such as products, and packages. Particularly, conventional label printers are loaded with a label spools that includes a plurality of labels and is configured to dispense at least one label on a target surface of the product, packages and the like objects. Furthermore, such labels may include product information or data about the products or packages. However, there are challenges in labelling right labels to the correct product or package in an optimum amount of time to reduce the overall cost and enable hassle free handling of the goods and products.

Major challenges can result from incorrect labelling of goods and products due to human error. Inadvertent use of the wrong label may not be detected during labeling, leading to improper handling of a package that may in turn cause loss of a product, loss of time, or loss of valuable goods or products. In addition, incorrect labelling may result in disorganized items that are difficult to sort through, move, reposition, locate, and then deliver to the right person or location. This may also result in lost time, damage to inventory that is improperly handled during searching, resorting, and repositioning, returns due to damage, or increased cost of handling the goods and products from added time, wages, fuel costs, and sometimes re-handling charges to make the transfer successful. However, in extreme scenarios, the loss may be significant disruption of an entire supply chain, which may result in high monetary loss.

Therefore, there is a need to overcome the challenges associated with conventional label printers and to mitigate the losses and costs that may be associated.

### SUMMARY

The present subject matter relates to a label printer which includes an optical recognition component. In some embodiments, the label printer is capable of one or more of scanning, printing and applying processes, and may be combined into a novel one-piece handheld solution. In some embodiments, the label printer may support faster or more accurate labeling, such as for markdowns, promotional labeling at retail, or inventory management, such as within manufacturing and distribution. In some embodiments, a handheld label printer enables scanning and integrated print and apply capabilities to perform markdown and promotional labeling with greater speed or accuracy than conventional techniques.

Some embodiments include a color sensor that detects a color associated with a label before printing, which may help with more accurate or faster printing and application of labels on target surfaces.

In some embodiments, a handheld label application device comprises a housing assembly comprising a holder component and a flap component. Furthermore, the flap component may be coupled and/or hinged to the holder component. The handheld label application device may also comprise a grip mounted to the housing assembly and adapted to assist switching of the flap component from a closed state to an open state of the housing assembly.

In some embodiments, the handheld label application device also comprises a print head mounted inside the housing assembly. The handheld label application device may also comprise a label roll spool detachably mounted inside the housing assembly. The label roll spool may comprise an array of labels with at least one optical attribute. Furthermore, in some embodiments, the at least one optical attribute is a color of the label.

In some embodiments, the handheld label application device comprises a print head retainer disposed within the housing assembly. The handheld label application device may also comprise a sensor positioned to an underside of the print head retainer. The sensor may be configured to detect the at least one optical attribute of the labels. The sensor may be configured to act upon a center of labels to detect the at least one optical attribute of the labels.

In some embodiments, the handheld label application device comprises a printed circuit board located within the print head retainer, and the sensor may be embedded on the printed circuit board. In various embodiments, the sensor is a color sensor including a photoelectric sensor and/or a photoelectric sensor. Moreover, the sensor may be configured to determine the color of the labels based on RGB values. The handheld label application device may also comprise an output module mounted on the housing assembly and that is communicably coupled to the sensor. The output module may include a graphical user interface and/or a display. In some embodiments, the handheld label application device comprises a scanner for scanning a barcode attached to or on an object. in some embodiments, the barcode comprises a product data related to the associated object. In an embodiment, the array of labels comprises multicolored labels with die cut gaps between one to another.

Some embodiments include a label application system that may include the handheld label application device. In various embodiments, the label application system comprises a hardware component communicably coupled to the handheld label application device and that is configured to provide corresponding product data, which may be related to at least one optical attribute of one or more labels. Furthermore, the hardware component may include computing hardware with a display screen, such as a mobile device, computer, or tablet. In some embodiments, the label application system comprises a central database communicably coupled to the handheld label application device and the hardware component, such as for monitoring the handheld label application device or the hardware component. Furthermore, the central database may be configured to store and transmit the corresponding product data related to the at least one optical attribute of the labels. The central database may be configured to authenticate and track the handheld label application device and the hardware component. In an embodiment, the label application system may comprise a scanner for scanning a barcode attached on an object, and the barcode comprises a product data related to the associated object.

Some embodiments provide a method for operating a handheld label application device that includes loading a label roll spool mounted to a housing assembly. The label roll spool may include an array of labels with at least one optical attribute. The method may also include scanning a barcode label attached on an object. The barcode may include a product data related to the associated object. The method may also include detecting at least one optical attribute of a label using a sensor positioned inside the housing assembly. The method may also include displaying the at least one optical attribute corresponding to the product data related to the at least one optical attribute of the labels. The method may also include dispensing the label with the corresponding product data related to the optical attribute of the labels. In some embodiments, the method also comprises applying the dispensed labels on objects. In various embodiments, the method also comprises aiming the sensor at a center of one or more labels to detect at least one optical attribute of the one or more labels. In some embodiments, the method also comprises pausing the dispensing of the label on or after detecting a mismatch of the at least one optical attribute with the corresponding object.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF DRAWINGS

The summary above, as well as the following detailed description of illustrative embodiments, is better understood when read in conjunction with the appended drawings. For the purpose of illustrating the present subject matter, exemplary constructions of the subject matter are shown in the drawings. However, the present subject matter is not limited to specific methods and instrumentalities disclosed herein. Moreover, those in the art will understand that the drawings are not to scale. Wherever possible, like elements have been indicated by identical numbers.

Embodiments of the present subject matter will now be described, by way of example only, with reference to the following diagrams wherein:

FIG. 1 is an illustration of a perspective view of a handheld label application device in an open state, in accordance with some embodiments of the present subject matter;

FIG. 2 is an illustration of a front view of the handheld label application device in an open state, in accordance with some embodiments of the present subject matter;

FIG. 3A is an illustration of a front perspective view of the handheld label application device, in accordance with some embodiments of the present subject matter;

FIG. 3B is an illustration of a rear perspective view of the handheld label application device, in accordance with some embodiments of the present subject matter;

FIG. 4A is an illustration of a cross-sectional view of the handheld label application device, in accordance with some embodiments of the present subject matter;

FIG. 4B is an illustration of a magnified cross-sectional view of the handheld label application device, in accordance with some embodiments of the present subject matter;

FIG. 5A is an illustration of a schematic diagram of the array of labels with single-colored labels, in accordance with some embodiments of the present subject matter;

FIG. 5B is an illustration of a schematic diagram of the array of labels in multicolored labels, in accordance with some embodiments of the present subject matter;

FIG. 6 is an illustration of a schematic diagram of a bottom perspective view of the print head retainer, in accordance with some embodiments of the present subject matter;

FIG. 7 is an illustration of a bottom perspective view of the label application system, in accordance with some embodiments of the present subject matter;

FIGS. 8A, 8B and 8C are illustrations of schematic diagrams of test graphs 800A, 800B and 800C of ten blue labels depicting (Red-Green-Blue values), in accordance with some embodiments of the present subject matter;

FIGS. 9A, 9B and 9C are illustrations of schematic diagrams of test graphs of ten green labels depicting (Red-Green-Blue values), in accordance with some embodiments of the present subject matter;

FIGS. 10A, 10B and 10C are illustrations of schematic diagrams of test graphs of ten pink labels depicting (Red-Green-Blue values), in accordance with some embodiments of the present subject matter;

FIGS. 11A, 11B and 11C are illustrations of schematic diagrams of test graphs of ten yellow labels depicting (Red-Green-Blue values), in accordance with some embodiments of the present subject matter; and

FIG. 12, is an illustration of a flow chart of a method for operating a handheld label application device, in accordance with some embodiments of the present subject matter.

In the accompanying drawings, an underlined number is employed to represent an item over which the under lined number is positioned or an item to which the under lined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION

In overview, some embodiments of the present subject matter relate to handheld or other printers, which may include label printers, as well as various other embodiments. Some embodiments include a. handheld label application device with a color sensor for detecting a color of a label in advance of printing of the label to a surface of a good or products.

The following detailed description illustrates various embodiments of the present subject matter and ways in which they may be implemented. Although some modes of carrying out the present subject matter have been disclosed, those skilled in the art would recognize that other embodiments for carrying out or practicing the present subject matter are also possible. Some disclosed embodiments include one or more of methods, devices, and/or systems for labelling and printing of labels on goods and products have been disclosed herein.

In some aspects, some embodiments of the present disclosure may include a handheld label application device comprising:
a housing assembly comprising a holder component and a flap component;
a print head mounted inside the housing assembly;
a label roll spool is detachably mounted inside the housing assembly, wherein the label roll spool comprises an array of labels with at least one optical attribute;
a print head retainer disposed within the housing assembly;
a sensor positioned to an underside of the print head retainer, wherein the sensor is configured to detect the at least one optical attribute of the labels; and
an output module mounted on the housing assembly and communicably coupled to the sensor.

In some aspects, some embodiments of the present disclosure include a label application system comprising:
a handheld label application device comprising:
   a housing assembly comprising a holder component and a flap component;
a print head mounted inside the housing assembly;
   a label roll spool is detachably mounted inside the housing assembly, wherein the label roll spool comprises an array of labels with at least one optical attribute;
   a print head retainer disposed within the housing assembly;
   a sensor positioned to an underside of the print head retainer, wherein the sensor is configured to detect the at least one optical attribute of the labels; and
   an output module mounted on the housing assembly and communicably coupled to the sensor;
a hardware component communicably coupled to the handheld label application device and configured to provide corresponding product data related to the at least one optical attribute of the labels; and
a central database communicably coupled to the handheld label application device and the hardware component to monitor the handheld label application device and the hardware component.

In some aspects, some embodiments of the present disclosure provide a method of operating a handheld label application device, comprising:
loading a label roll spool mounted to a housing assembly, wherein the label roll spool comprises an array of labels with at least one optical attribute;
scanning a barcode label attached on an object, wherein the barcode comprises a product data related to the associated object;
detecting at least one optical attribute of a label using a sensor positioned inside the housing assembly;
displaying the at least one optical attribute corresponding to the product data related to the at least one optical attribute of the labels; and
dispensing the label with the corresponding product data related to the optical attribute of the labels.

Throughout the present disclosure, the term “handheld label application device” may refer to, among other devices, a handheld label printer configured to dispense and apply labels, such as on to surfaces. The surfaces may include, but are not limited to, goods, products, or packages. Furthermore, the handheld label application devices may be loaded with label roll spools consisting a strip of multiple labels. In some embodiments, the labels may or may not be provided with a releasable liner that detaches at the edge of the handheld label printers while dispensing and thereafter applied to surfaces of goods, products, or packages. Such labels may be provided with an adhesive that allows detachment from releasable liners and/or firm attachment to a surface, such as for goods, products, or packages.

In some embodiments, labels may be embedded or produced with product data, a unique product code or details, and/or a unique cryptographic code such as barcodes or QR codes. In some labels, the data may be encrypted to enable track and trace while a package is in transfer. The data may include one or more of a batch type, a price, a price update, and/or an address. This data may be useful during manufacturing, supply or delivery. In some embodiments, the labels possess both machine and human readable parameters. Labelling a product or another inventory item with one or more unique product codes can provide track and traceability information of the product or the inventory item in a supply chain, or while the item is stored on a shelf, in a store, in inventory storage, and/or in a warehouse. In some applications and embodiments, the labels are manufactured with unique product codes, product data, and/or other information, one or more of which may be encrypted.

In some embodiments, the handheld label application device includes a sensor. The sensor may be mounted inside the handheld label application device to detect or sense one or more optical attributes, such as an optical attribute of, on, associated with, or related to one or more labels. In various embodiments, the sensor may include one or more of a color sensor, a photoelectric sensor and/or an optical sensor.

The handheld label application device as disclosed in the present subject matter may be very beneficial in a retail environment or a warehouse where sorting is done, such as to segregate various kinds of products or packages. In some embodiments, the handheld label application device may automatically detect the color of a label which is on a supply roll inside or otherwise feeding the handheld label application device. The handheld label application device may confirm that the correct colored label or other required attributed label is applied to the end product/package, such as in a last mile facility. By using the optical attribute of a label such as a color, the system may support one or more functions or objectives. These functions may include one or more of confirming that a label of a desired type is being used, associating a particular color of label together with a particular package, tracking what color labels are being used at a particular station or other location, tracking what color label is being applied by a particular person at a particular time.

By using a label having a particular optical characteristic such as a color, human or other types of package handlers may be enabled to quickly sort, route, identify, and/or locate packages for delivery or other purposes. Use of one or more optical characteristics may help provide an additional safeguard against failure to deliver, loss of a package, misdelivery, or other issues.

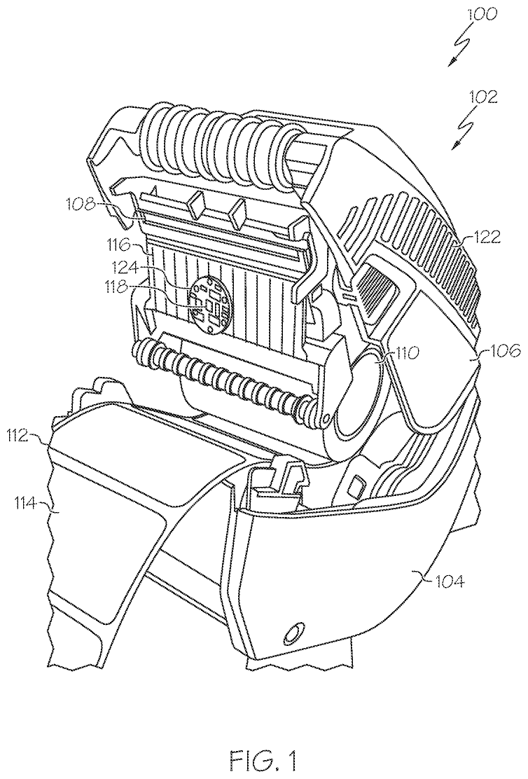

Referring to FIG. 1, there is shown an illustration of a schematic diagram of a handheld label application device 100 in an open state, in accordance with an embodiment of the present subject matter. The handheld label application device 100 comprises a housing assembly 102 including a holder component 104 and a flap component 106. The handheld label application device 100 also comprises a print head 108, and as illustrated, contains a label roll spool 110 that is a supply item for the handheld label application device 100. The label roll spool 110 comprises an array of labels 112 with at least one optical attribute 114. The handheld label application device 100 also comprises a print head retainer 116, a sensor 118 mounted on a printed circuit board 124, and an output module 120.

As shown, the handheld label application device 100 is constructed with the housing assembly 102. The housing assembly 102 is a frame or a body of the handheld label application device 100. The housing assembly 102 may be provided with the holder component 104 at the top and the flap component 106 at the bottom. In some embodiments, the flap component 104 is coupled (shown herein below) to the holder component 106. Furthermore, the holder component 106 may be constructed to be static and/or fixed whilst the flap component 104 to pivot at a rear end of the holder component 106. In another embodiment, the flap component 104 is coupled with a hinge to the holder component 106 at the rear end of the holder component 106. In various embodiments, the flap component 104 is coupled to the holder component 106 using one or more of screws, nut-bolts, latches, or other coupling mechanisms. The flap component 104 is adapted to rest on the holder component 106 in a closed state of the housing assembly 102. The flap component 104 is also adapted to stand in an upright position on the holder component in the open state of the housing assembly 102.

In an embodiment, the handheld label application device 100 comprises a grip 122 mounted to the housing assembly 102. The grip 122 as used herein refers to a strap of material applied to objects and adapted to assist grasp or hold to the objects. The grip 122 as used herein is adapted to assist with switching of the flap component 104 from the closed state to the open state of the housing assembly 102. Furthermore, the closed state is the operating position of the handheld label application device 100 and the open state is the loading position or non-operating position of the handheld label application device 100.

In some embodiments, the print head 108 is mounted inside the housing assembly 102. The print head 108 may include or be a print mechanism or a print member that enables or actuates print of the handheld label application device 100. As depicted in FIG. 1, the print head 108 is located at the underside of the flap component 104. The print head 108 may include cartridges that allows printing of the labels 112. In various embodiments, the print head 108 may be configured to print or transfer ink on the labels 112. In an example, the print head 108 may print shapes, characters, alphabets, numbers, or other designs on the labels 112.

In some embodiments, the label roll spool 110 is detachably mounted inside the housing assembly 102. The label roll spool 110 may refer to a cylindrical element that may include two discs attached at its extreme ends and adapted to hold a film or strip or reel of labels. Label roll spool 110 may be mounted inside the housing assembly 102 and at a juncture of the flap component 104 and the holder component 106. As shown in FIG. 1, the label roll spool 110 is mounted to the flap component 104 and the holder component 106 may allow accommodation of the label roll spool 110 to be received therein. In the closed state of the handheld label application device 100 the label roll spool 110 may rest inside the holder component 106.

In accordance with an embodiment, the label roll spool 110 may include a reel of the array of labels 112 with at least one optical attribute 114, as depicted in FIG. 1. The array of labels 112 may refer to a substrate or one or more pieces of or sheets of material that may placed on a liner or a film. In various embodiments, the array of labels 112 may be placed with or without a liner or substrate on a reel. In various embodiments, the array of labels 112 may include a layer of adhesive at the base of labels 112 that may be released from the liner to be printed on goods and products. The optical attribute 114 of the array of labels 112 or labels 112 may include one or more visual aspects of a labels, including, but not limited to one or more colors of the label, a character, a pattern, a printed shape, or an image.

In some embodiments, the print head retainer 116 disposed within the housing assembly 102. The print head retainer 116 is located at the bottom of the print head 108. The print head retainer 116 as used herein refers to a holding structure that assists mounting of the print head 108 to the housing assembly 102. As shown in FIG. 1, the print head 108 and the print head retainer 116 are mounted to the underside of the flap component 104. In the closed state or operating position of the handheld label application device 100, the print head 108 and the print head retainer 116 may be accommodated within the juncture of the flap component 104 and the holder component 106. In some embodiments when the handheld label application device 100 is at a closed state, the print head 108 and the print head retainer 116 may be disposed adjacent to one or more labels of the array of labels 112. In some embodiments, the holder component 106 may accommodation of the print head 108 and the print head retainer 116 therein.

In some embodiments, the sensor 118 is positioned to an underside of the print head retainer 116. The sensor 118 may be mounted to the print head retainer 116 in relation to the position of the label roll spool 110 and the array of labels 112. In various embodiments, the sensor 118 is embedded on the printed circuit board 124. As shown in FIG. 1, the sensor 118 is geometrically aligned with the array of labels 112 to enable efficient detection of the at least one optical attribute 114 of at least one label 112 from the array of labels 112.

In some embodiments, the handheld label application device 100 is configured to detect or sense optical attributes 114 of the labels 112 that are adapted to be applied on the goods, products and objects. As disclosed herein, the term “optical attribute” refers to a visual aspect of labels, including, but not limited to a color of the label 112. In various embodiments, the optical attributes may include one or more of a particular color, image, shape, design, pattern, marking, feature, or texture that is a part of, printed on, embossed into, or otherwise associated with one or more labels 112 and/or a part of a liner that may be supporting the one or more labels.

In some embodiments, the sensor 118 is configured to detect the at least one optical attribute 114 of the labels 112. In an embodiment, the optical attribute 114 may be visually detectable and recognized by a sensor, machine, and/or a person, and may include or lack one or more numbers or letters. For example, the color(s) of a label may include one or more of yellow, green, blue, red, orange, pink, yellow, purple, brown, black, white, magenta, ocher, tan, silver, gold, beige, reflective, transparent, or iridescent. An image or shape may include part or all of an image or shape associated with a particular person, place, animal, plant, or other object. For example, a label may be shaped like a closed or open circle, triangle, square, rectangle, star, trapezoid, dodecahedron, oval, or other shape. In another example, the shapes or images of a label may be used to form the shape of a label or may be printed on, cut out of, or adhered to a label, and may include one or more of deer, birds, owls, insects, trees, or other objects. For example, the sensor may be able to sense the color of the labels before printing on the surface. Beneficially, knowing an optical characteristic of a label, such as a label color, in advance may help in applying the label on the appropriate surface and may prevent improper application of a particular color or other type of label on a package. In an exemplary embodiment, the handheld label application device 100 may include a feedback mechanism or a stopping mechanism or a pausing mechanism. Furthermore, the handheld label application device 100 may hold or otherwise stop or pause the printing of the labels 112 on detection of mismatch of the optical attribute 114 for the object in order to applied therewith.

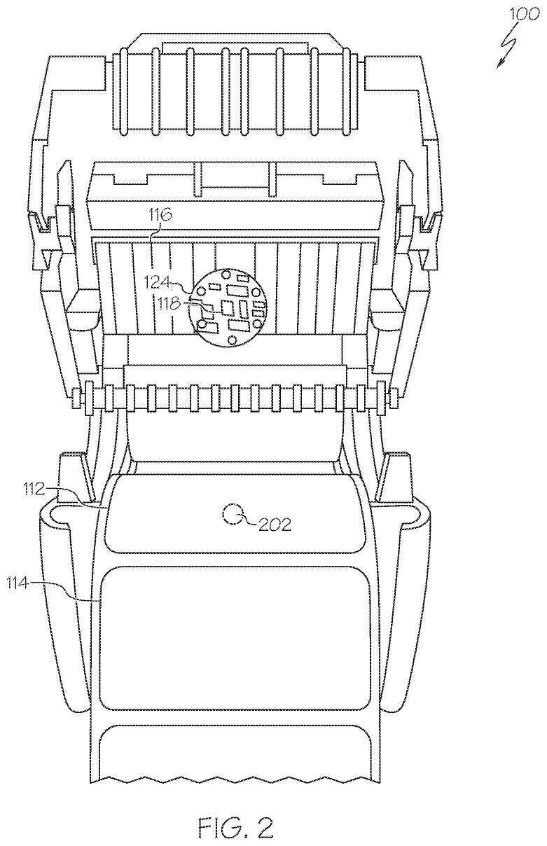

Referring to FIG. 2, there is shown an illustration of a schematic diagram of the handheld label application device 100 (same as shown in FIG. 1), in accordance with an embodiment of the present subject matter. In some embodiments, the sensor 118 is configured to act upon a center 202 of labels 112 to detect the at least one optical attribute 114 of the labels 112. As shown in FIG. 2, the center 202 is an imaginary circle and depicted using a broken line, for illustration purpose, and it forms no part of the handheld label application device 100. As depicted in FIG. 2, the printed circuit board 124 is mounted to the printed circuit board 124 in alignment with the array of labels 112. The sensor 118 is configured to create or otherwise direct radiant light ray on the center 202 of labels 112 to enhance detection of the at least one optical attribute 114 of the labels 112, such as inside the handheld label application device 100. In some embodiments, the sensor 118 is a color sensor. In various embodiments, the color sensor includes or is a photoelectric sensor and/or a photoelectric sensor. In some embodiments, the color is measured from color filters with precise responses from the sensor 118 allowing accurate computation of the color temperature (CCT) values and/or Lux (light sensor) information values. In some embodiments, the sensor 118 is configured to determine the color of the labels 112 based on RGB (red, green and blue) values and/or color hues.

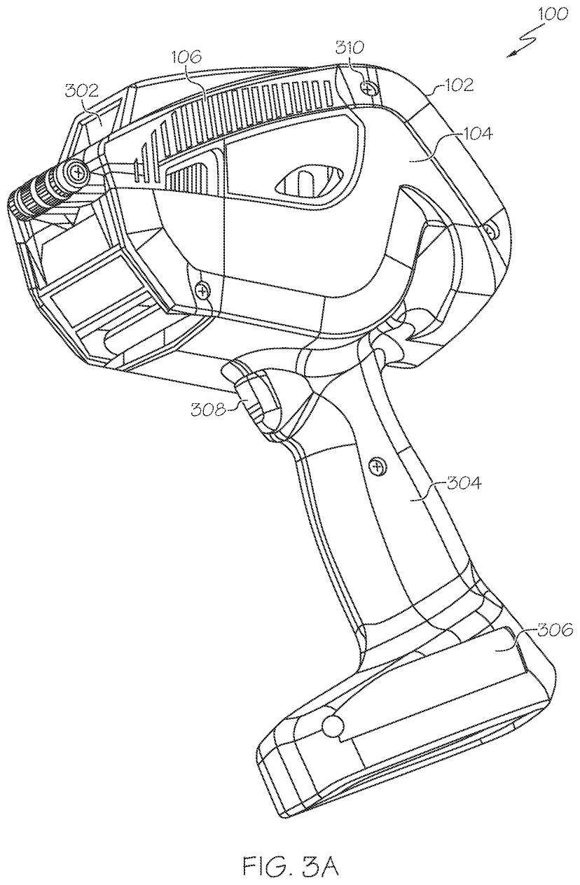

Referring to FIG. 3A, there is shown an illustration of a front perspective view of the handheld label application device 100 (same as shown in FIG. 1), in accordance with an embodiment of the present subject matter. Referring to FIG. 3B, there is shown an illustration of a rear perspective view of the handheld label application device 100 (same as shown in FIG. 1), in accordance with some embodiments of the present subject matter. In some embodiments, the handheld label application device 100 comprises a scanner 302 for scanning a barcode attached on an object. Furthermore, the barcode comprises a product data related to the associated object. The scanner 302 may be positioned at a leading front edge of the handheld label application device 100. In some embodiments, the handheld label application device 100 is triggered, such as on the object, to scan a barcode label and/or to dispense barcode and/or RFID labels on the objects. In some embodiments, the labels are identified, printed, and/or applied to the objects, and optical characteristic may be automatically transmitted by the handheld label application device 100 to a server or other computing device along with another identifying characteristic of the package or item that was labeled with the label having the optical characteristic. The information transmitted the server may further include an identification of a person logged into the handheld label application device 1001n some embodiments, the product data may be associated with, linked, or otherwise connected to the optical attribute of the labels. This may enable rapid identification of one of many packages or items by a downstream person or machine. For example, when a delivery person is looking for a very specific item for delivery, the system may be able to tell the delivery person to look for an optical characteristic that may be unique to the package or may be shared across some, but not all, of the packages in the environment to be searched. For example, the system may tell the delivery person based on a unique serial number associated with a package that the delivery person should be looking for a green label, or a green/blue label, or a combination of green labels and pink labels. In other embodiments, the system may tell a person to look for packages labeled with a blue star shaped or printed label.

In various embodiments, the handheld label application device 100 also comprises a handle 304 coupled to the bottom of the housing assembly 102 (same as shown in FIG. 1). Furthermore, the handle 304 may be manufactured using the same m as the housing assembly 102. The handle 304 is provided to assist a user in holding the handheld label application device 100 in an upright position to apply the labels. In some embodiments, the handheld label application device 100 also comprises a stand base 306 coupled to the handle 304 and adapted to enable a placement of the handheld label application device 100 on a flat surface, when not in use. The stand base 306 may be manufactured using the same material as the housing assembly 102 and the handle 304. In some embodiments, the handheld label application device 100 also comprises a trigger knob 308 at the coupling of the housing assembly 102 and the handle 304. The trigger knob 308 is adapted to actuate or trigger printing and/or scanning of the handheld label application device 100. In an embodiment, the handheld label application device 100 also comprises a hinge coupling 310 to couple the holder component 104 and the flap component 106.

In some embodiments, the handheld label application device 100 comprises an output module 120 mounted on the housing assembly 102 and communicably coupled to the sensor 118 (same as shown in FIG. 1). In an embodiment, the output module 120 is a graphical user interface and/or a display 312. In some embodiments, the output module 120 may be configured to display the optical characteristic or characteristics (e.g., a color, shape, number, and/or letter) of the label detected from the sensor 118. In an exemplary embodiment, the output module 120 displays a product data of an object being scanned or subjected to be printed with the label thereon. The handheld label application device 100 may also comprises a charger port 314 positioned at the stand base 306 and adapted to plug in a charger (e.g., a power source charger input) to provide electrical power to the handheld label application device 100.

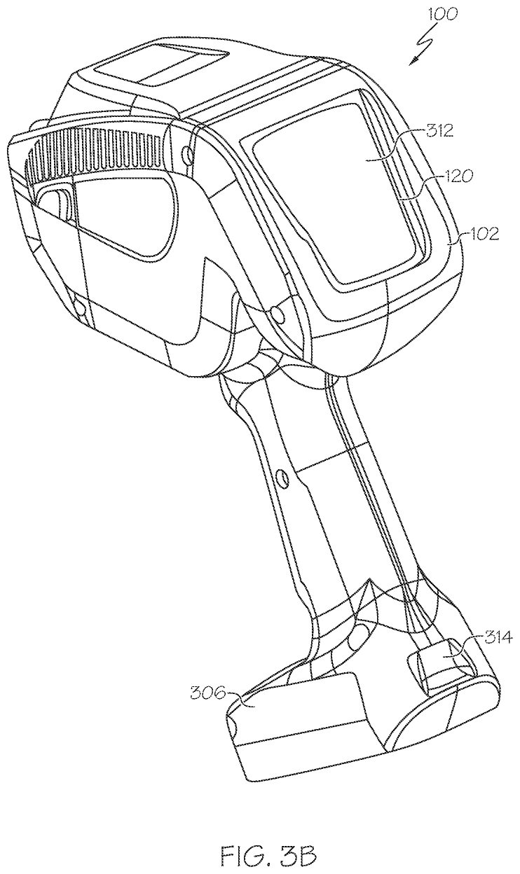

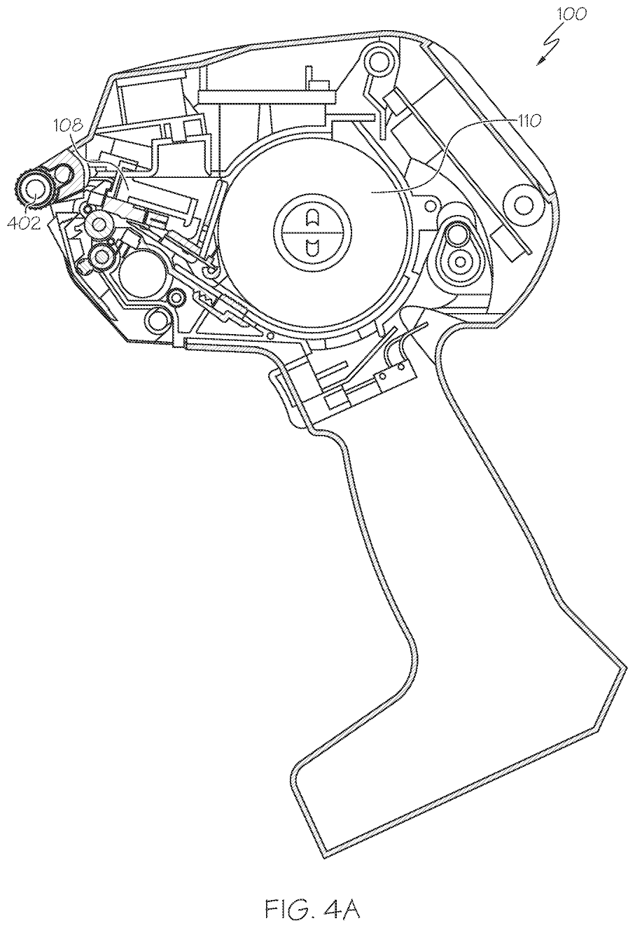

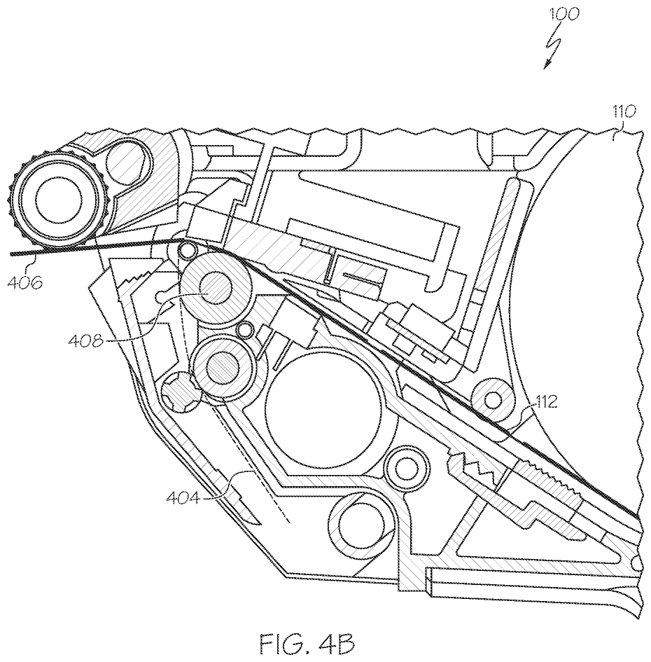

Referring to FIG. 4A and FIG. 1, there is shown an illustration of a cross-sectional view of the handheld label application device 100 (e.g, as shown in FIG. 1), in accordance with an embodiment of the present subject matter. Referring to FIG. 4B, there is shown an illustration of a magnified cross-sectional view of the handheld label application device 100, in accordance with an embodiment of the present subject matter. The handheld label application device 100 may include a de-laminator 402 to release a carrier web liner 404 from one or more labels before dispensing delaminated labels 406. The handheld label application device 100 may comprise a rotor 408 to rotate the label roll spool 110 to dispense the array of labels 112.

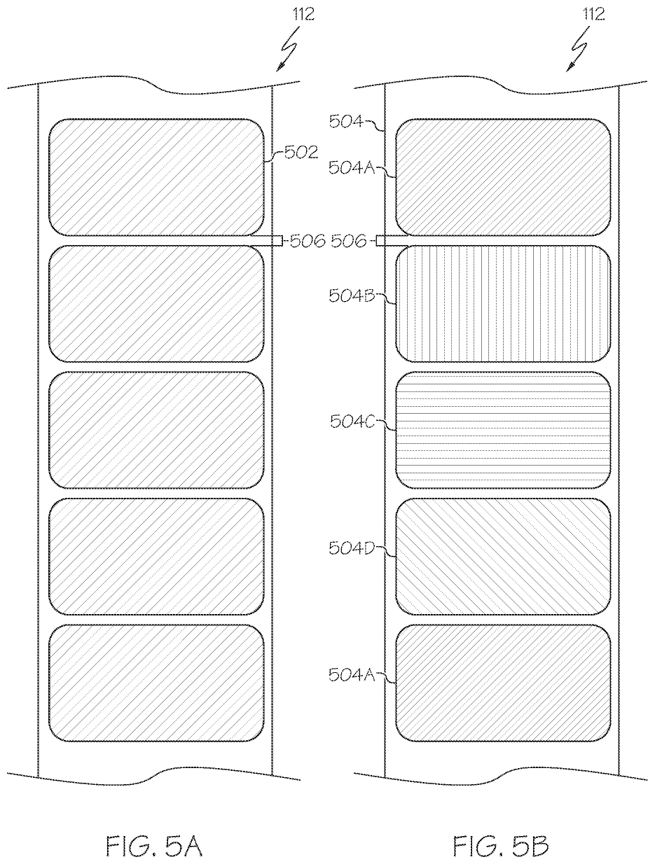

Referring to FIGS. 5A and 1, there is shown an illustration of a schematic diagram of the array of labels 112 with single-colored labels 502 (e.g., as shown in FIG. 1), in accordance with an embodiment of the present subject matter. Referring to FIG. 5B, there is shown an illustration of a schematic diagram of the array of labels 112 in multicolored labels 504 (e.g., as shown in FIG. 1), in accordance with an embodiment of the present subject matter. The single-colored labels 502 may be partly or entirely green, yellow, red, or blue. In another embodiment, the array of labels 112 in multicolored labels 504 are green 504A, yellow 504B, red 504C and blue 504D. Furthermore, the array of labels 112 may comprise die cut gaps 506 between one to another.

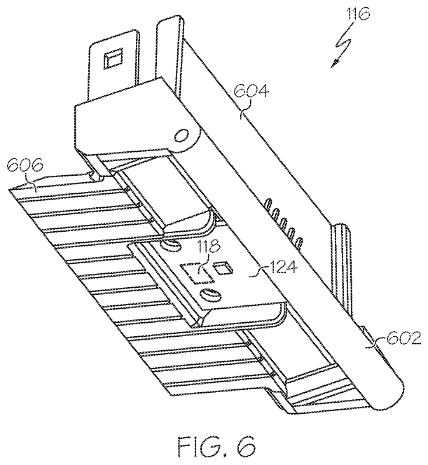

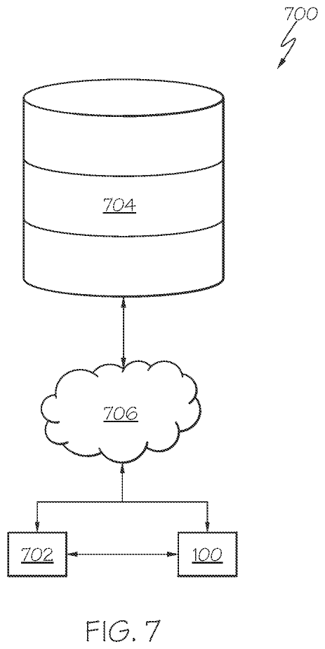

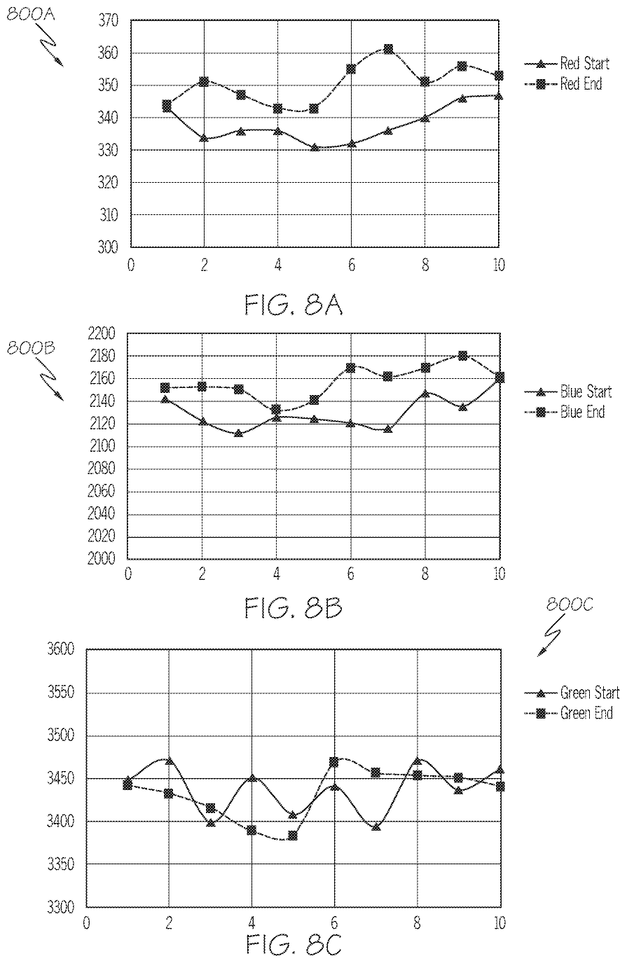

Referring to FIG. 6, there is shown an illustration of a bottom perspective view of the print head retainer 116 (e.g., as shown in FIG. 1), in accordance with an embodiment of the present subject matter. As shown, the printed circuit board 124 is located at the bottom of the print head retainer 116. Furthermore, the printed circuit board 124 includes the sensor 118 at the bottom of the print head retainer 116. The print head retainer 116 also includes a cylindrical support member 602, a vertical support member 604 and a lateral support member 606.

Referring to FIG. 7, there is shown an illustration of a block diagram of the label application system 700, in accordance with an embodiment of the present subject matter. In some embodiments, the label application system 700 comprises the handheld label application device 100, a hardware component 702 communicably coupled to the handheld label application device 100 and a central database 704 communicably coupled to the handheld label application device 100 and the hardware component 702. The handheld label application device 100 is the same as shown FIG. 1. In an embodiment, the handheld label application device 100 and the hardware component 702 is connected to the central database 704 over a cloud network 706.

In some embodiments, the hardware component 702 is configured to provide corresponding product data related to the at least one optical attribute of the labels. In various embodiments, the central database 704 stores and transmit the corresponding product data related to the at least one optical attribute of the labels. In some embodiments, the central database 704 is configured to authenticate and track the handheld label application device 100 and the hardware component 702. In some embodiments, the central database 704 is configured to authenticate and track products, packages, or items based on information provided by the handheld label application device 100 and/or the hardware component 702. In an exemplary embodiment, the handheld label application device 100 is at a labeling section of a warehouse and a user (handheld label application device handler) is authenticated from the central database 704. In some scenarios, the central database 704 transmits the corresponding product data related to the at least one optical attribute of the labels with the objects to be labeled. In some scenarios, the central database 704 receives the corresponding product data (e.g., an item serial number) and/or the at least one optical attribute of the labels from the handheld label application device. This may enable the system to identify which items were labeled with a particular optical characteristic (e.g., a particular color label). This may in turn allow a system to identify for a delivery person the fact that the specific item they need to deliver is one of the multiple items having a semi-unique optical characteristic (e.g., the item is one of multiple blue labeled items). In some embodiments, the hardware component 702 is a computing hardware with a display screen and populates the corresponding product data related to the at least one optical attribute on the display screen. In another embodiment, label application system 700 comprises a scanner (e.g., the scanner 302 as shown in FIG. 3A) for scanning a barcode attached on an object. The barcode comprises a product data related to the associated object. In such an embodiment, the labels are applied to objects with matching corresponding product data related to the optical attribute of the labels. Furthermore, the at least one optical attribute is a color of the label.

Referring to FIGS. 8A, 8B and 8C, there is shown an illustration of schematic diagrams of test graphs 800A, 800B and 800C of ten blue labels depicting (Red-Green-Blue values), in accordance with an embodiment of the present subject matter. In some embodiments, the impact of label curl near an end of a roll of labels on values measured by a color sensor (sensor 118 as shown in FIG. 1).

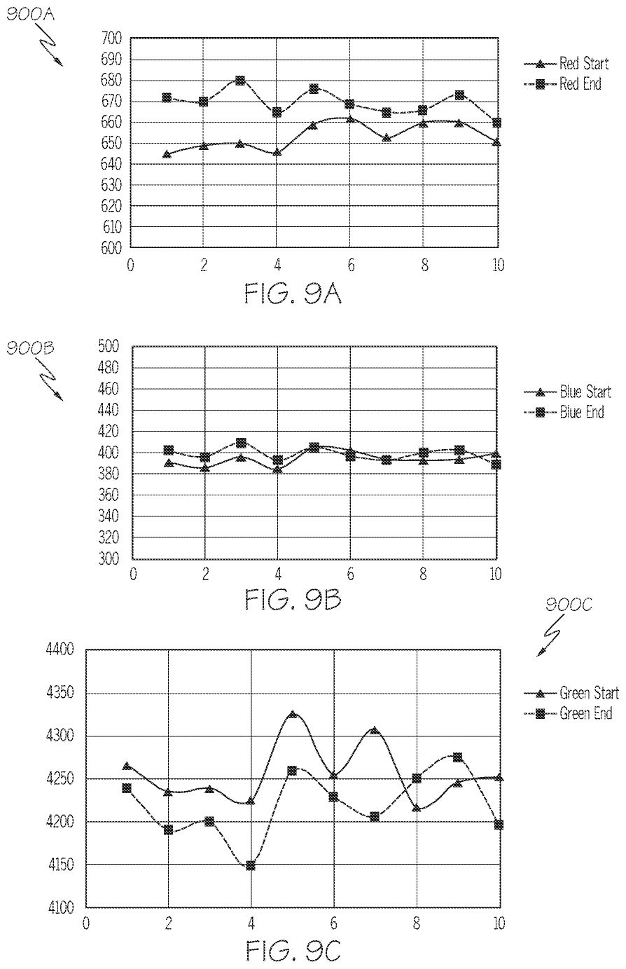

Referring to FIGS. 9A, 9B and 9C, there is shown an illustration of schematic diagrams of test graphs 900A, 900B and 900C of ten green labels depicting (Red-Green-Blue values), in accordance with an embodiment of the present subject matter.

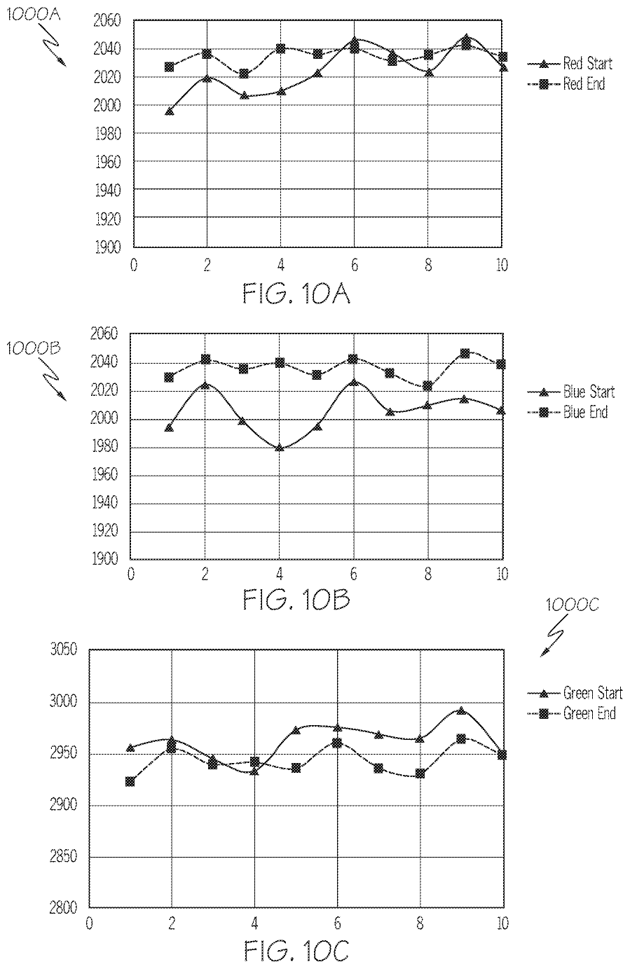

Referring to FIGS. 10A, 10B and 10C, there is shown an illustration of schematic diagrams of test graphs 1000A, 1000B and 1000C of ten pink labels depicting (Red-Green-Blue values), in accordance with an embodiment of the present subject matter.

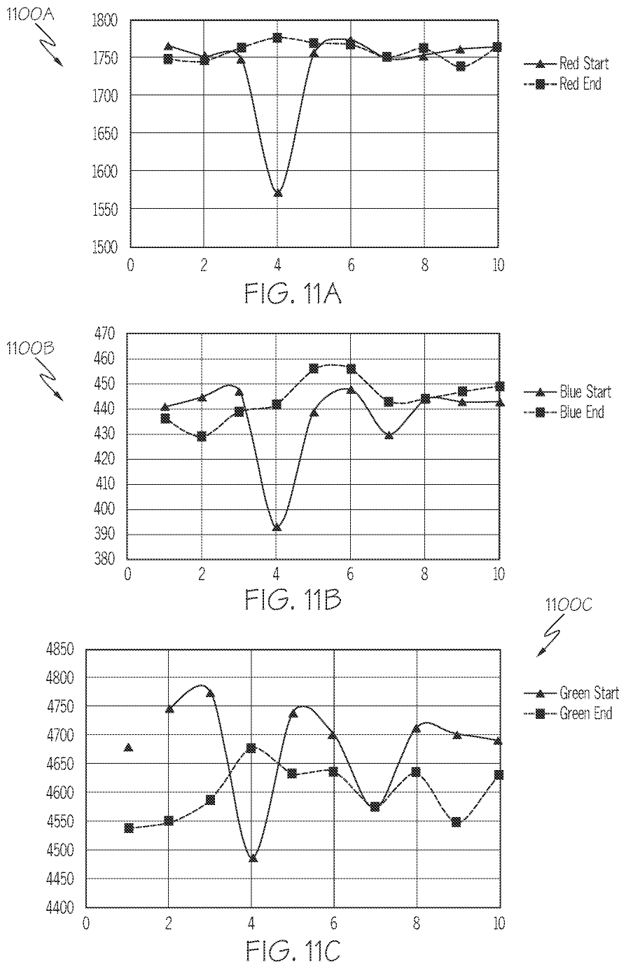

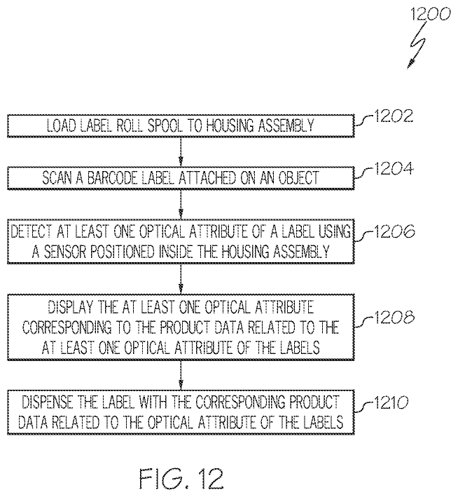

Referring to FIGS. 11A, 11B and 11C, there is shown an illustration of schematic diagrams of test graphs 1100A, 1000B and 1100C of ten yellow labels depicting (Red-Green-Blue values), in accordance with an embodiment of the present subject matter.

Referring to FIG. 12, there is shown an illustration of a flow chart of a method 1200 for operating a handheld label application device, in accordance with an exemplary embodiment of the present subject matter.

At step 1202, a label roll spool 112 is loaded to a housing assembly 102, wherein the label roll spool 112 comprises an array of labels 112 with at least one optical attribute 114.

At step 1204, a barcode label attached on an object is scanned. The barcode comprises a product data related to the associated object.

At step 1206, at least one optical attribute 114 of a label is detected using a sensor 118 positioned inside the housing assembly 102.

At step 1208, the at least one optical attribute 114 corresponding to the product data related to the at least one optical attribute 114 of the labels is displayed.

At step 1210, the label 112 with the corresponding product data related to the optical attribute 114 of the labels 112 is dispensed.

In some embodiments, the method 1200 also comprises applying the dispensed labels on objects. Furthermore, the labels are applied to the objects with matching corresponding product data related to the optical attribute of the labels. In an embodiment, the corresponding product data related to the optical attribute of the labels are compared to validate the dispensing of labels on corresponding correct objects. Furthermore, the sensor is a color sensor, the color sensor is a photoelectric sensor and/or a photoelectric sensor. Moreover, the sensor is configured to determine the color of the labels based on RGB values. Furthermore, the array of labels comprises multicolored labels with die cut gaps between one to another.

In some embodiments, the method 1200 also comprises aiming the sensor to a center of one or more labels to detect the at least one optical attribute of the labels. In various embodiments, the method 1200 also comprises pausing the dispensing of the label on detecting a mismatch of the at least one optical attribute with the corresponding object. In some embodiments, the at least one optical attribute is a color of the label.

Modifications to embodiments of the present subject matter described in the foregoing are possible without departing from the scope of the present subject matter as defined by the accompanying claims. Expressions such as “including”, “comprising”, “incorporating”, “have”, “is” used to describe and claim the present subject matter are intended to be construed in a non-exclusive manner, namely allowing for items, components or elements not explicitly described also to be present. Reference to the singular is also to be construed to relate to the plural.

1. A handheld label application device comprising:
a housing assembly;
a print head mounted inside the housing assembly and configured to print on a label;
a sensor positioned inside the housing assembly, wherein the sensor is configured to detect at least one optical attribute of a label before it is printed on by the printer;
a print head retainer disposed within the housing assembly; and
a printed circuit board located within the print head retainer, wherein the sensor is embedded on the printed circuited board.

2. The device of claim 1,
wherein the housing assembly comprises a holder component and a flap component;
wherein the housing assembly comprises a label roll spool detachably mounted inside the housing assembly, and wherein the label roll spool comprises an array of labels with at least one optical attribute;
wherein the sensor is mounted to an underside of the print head retainer, and
wherein the device further comprises an output module mounted on the housing assembly and communicably coupled to the sensor.

3. The device of claim 2, wherein the flap component is coupled to the holder component, wherein the flap component is hinged to the holder component.

4. The device of claim 2, further comprising a grip mounted to the housing assembly and adapted to assist switching of the flap component from a closed state to an open state of the housing assembly.

5. The device of claim 1, wherein the at least one optical attribute is a color of the label.

6. The device of claim 1, wherein the sensor is configured to act upon a center of labels to detect the at least one optical attribute of the labels.

7. (canceled)

8. The device of claim 1, wherein the sensor is a color sensor, the color sensor is a photoelectric.

9. The device of claim 8, wherein the sensor is configured to determine the color of the labels based on RGB values.

10. The device of claim 8, further comprising an output module, wherein the output module is a graphical user interface and/or a display.

11. The device of claim 10, further comprising a scanner for scanning a barcode attached on an object, wherein the barcode comprises a product data related to the associated object.

12. The device of claim 11, wherein the handheld label application device is configured to trigger on the object to scan the barcode label and to dispense the labels on the object.

13. The device of claim 12, wherein the array of labels comprises multicolored labels with die cut gaps between one to another.

14. A label application system comprising:
a handheld label application device comprising:
a housing assembly comprising a holder component and a flap component;
a print head mounted inside the housing assembly;
a label roll spool is detachably mounted inside the housing assembly, wherein the label roll spool comprises an array of labels with at least one optical attribute;
a print head retainer disposed within the housing assembly;
a sensor positioned to an underside of the print head retainer, wherein the sensor is configured to detect the at least one optical attribute of the labels; and
an output module mounted on the housing assembly and communicably coupled to the sensor;
a hardware component communicably coupled to the handheld label application device and configured to provide corresponding product data related to the at least one optical attribute of the labels; and
a central database communicably coupled to the handheld label application device and the hardware component, to monitor the handheld label application device and the hardware component.

15. The system of claim 14, further comprising a scanner for scanning a barcode attached on an object, wherein the barcode comprises a product data related to the associated object.

16. The system of claim 15, wherein the central database is configured to store and transmit the corresponding product data related to the at least one optical attribute of the labels.

17. The system of claim 14, wherein the central database is configured to authenticate and track the handheld label application device and the hardware component.

18. The system of claim 1 wherein the handheld label application device is configured to apply labels to objects with matching corresponding product data related to the optical attribute of the labels.

19. The system of claim 14, wherein the at least one optical attribute is a color of the label.

20. The system of claim 14, wherein the sensor is a color sensor, the color sensor is a photoelectric sensor.

21. The system of claim 14, wherein the sensor is configured to determine the color of the labels based on RGB values.

22. The system of claim 14, wherein the hardware component is a computing hardware with a display screen.

23. A method for operating a handheld label application device, comprising:
scanning a barcode label attached on an object, wherein the barcode comprises a product data related to the associated object;
using a sensor positioned inside the housing assembly, detecting at least one optical attribute of a label;
performing at least one of displaying the at least one optical attribute corresponding to the product data related to the at least one optical attribute of the labels and transmitting the at least one optical attribute and the product data to another computing device; and
dispensing the label.

24. The method of claim 23, further comprising:
loading a label roll spool mounted to a housing assembly, wherein the label roll spool comprises an array of labels with at least one optical attribute; and
displaying the at least one optical attribute corresponding to the product data related to the at least one optical attribute of the labels.
dispensing the label with the corresponding product data related to the optical attribute of the labels.

25. The method of claim 24, further comprising applying the dispensed labels on objects.

26. The method of claim 25, wherein the handheld label application device is configured to apply labels to the objects with matching corresponding product data related to the optical attribute of the labels.

27. The method of claim 26, further comprising aiming the sensor to a center of one or more labels to detect the at least one optical attribute of the labels.

28. The method of claim 27, further comprising pausing the dispensing of the label on detecting a mismatch of the at least one optical attribute with the corresponding object.

29. The device of claim 28, wherein the at least one optical attribute is a color of the label.

30. The method of claim 29, wherein the sensor is a color sensor, the color sensor is a photoelectric sensor.

31. The method of claim 30, wherein the sensor is configured to determine the color of the labels based on RGB values.

32. The device of claim 31, wherein the array of labels comprises multicolored labels with die cut gaps between one to another.
